(19) United States
(12) Patent Application Publication
(10) Pub. No.: US 2008/0281678 A1
(43) Pub. Date: Nov. 13, 2008

(54) PRACTICE MANAGEMENT ANALYSIS TOOL FOR FINANCIAL ADVISORS

(75) Inventors: Peter Keuls, Ridgefield, CT (US); Todd Crowley, Naperville, IL (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: MCLAGAN PARTNERS, INC., Stamford, CT (US)

(21) Appl. No.: 12/117,273

(22) Filed: May 8, 2008

Related U.S. Application Data
(60) Provisional application No. 60/917,011, filed on May 9, 2007.

(51) Int. Cl. G06F 17/30

(52) U.S. Cl. 705/10

(57) ABSTRACT

A practice management benchmarking tool may provide actionable feedback on practice and individual financial advisor performance that may identify how participants can improve their business. For example, the tool may provide a customized report that compares a practice's performance against other, relevant, local practices. The tool may also include an industry trend report that summarizes industry performance and compensation. An industry trend report may be relevant to larger corporate financial services companies with regional or national interests. The tool may provide a comparison analysis of a financial advisor practice according to three areas: 1) productivity and growth, 2) expenses, staffing, and profitability, and 3) individual financial planner productivity and pay.

### CROSS-REFERENCE TO RELATED APPLICATION

The present application claims the benefit of U.S. Provisional Application No. 60/917,011, entitled “PRACTICE MANAGEMENT ANALYSIS TOOL FOR FINANCIAL ADVISORS,” filed on May 9, 2007, which is hereby incorporated by reference herein in its entirety.

### FIELD OF THE INVENTION

This patent relates to the field of business management, and more particularly, to methods of analyzing the performance of a financial advisor's business against other financial services providers in relevant markets.

### BACKGROUND

Financial planning practices, like all business endeavors, strive to be efficient and profitable. One method financial advisors use to determine the effectiveness of their business is performance benchmarking analysis. In a typical scenario, an advisor sets market-based performance goals, tracks their performance against those goals, takes corrective action to continue toward the goals, and resets the goals, if needed. Computerized reporting tools and systems may assist financial advisors with the benchmarking process. However, past systems have failed to provide timely, relevant, and effective information. One past method required financial advisors to complete surveys that were then collected and analyzed for all members participating in the survey. Other methods merely provided analysis against practices that were geographically proximate to subject practices.

While the surveys compiled a comprehensive range of financial services, pay, and performance data with detailed benchmarks of each, final reports merely contained industry-wide or geographic or ZIP code-based trends that were likely irrelevant for most practices. Other analyses only used Metropolitan Statistical Areas (MSAs) from governmental census data. For example, in a common scenario, an advisor in St. Louis may have received a detailed report including the performance data of advisors in nearby, rural De Soto, Mo., other advisors across the United States, or in disparate locations with dissimilar experiences, markets, and goals for their practice. Previous reports also only presented market data without including an advisor's or practice's data, a statistical analysis, or a ranking among similar financial service providers.

Likewise, collecting detailed data from advisors delayed publication of benchmarking reports, making them irrelevant for taking corrective action in response. Further, highly detailed reports may conceal relevant information from the advisor and the scope and detail of benchmarking reports may cause other problems, as well. For example, the data collection burden on respondents is high and can take several hours to gather data to complete a survey of one's business. Finally, the value of any resulting report is compromised because of low participation and small sample size that degrades the accuracy of results that, as previously described, are not a representation of a relevant industry sector.

### SUMMARY

A practice management benchmarking tool may provide actionable feedback on practice and individual financial advisor performance that may identify how participants can improve their business. For example, the tool may provide a customized report that compares a practice's performance against other, relevantly similar practices. The tool may also include an industry trend report that summarizes industry performance and compensation. An industry trend report may be relevant to larger corporate financial services companies with regional or national interests. The tool may provide a comparison analysis of a financial advisor practice according to three areas: 1) productivity and growth, 2) expenses, staffing, and profitability, and 3) individual financial planner productivity and pay.

### BRIEF DESCRIPTION OF THE DRAWINGS

FIG. 1 is an exemplary illustration of a computer network;

FIG. 2 is an exemplary illustration of a computing device;

FIG. 3 is an exemplary illustration of a method for business management and planning;

FIG. 4 is an exemplary flowchart of a method for executing a practice management analysis tool for financial advisors;

FIG. 5 is an exemplary flowchart of a method for completing a data input template;

FIG. 6 is an exemplary illustration of a practice profile portion of a data input template for use with a practice management analysis tool for financial advisors;

FIGS. 7a-d are exemplary illustrations of a practice data portion of a data input template for use with a practice management analysis tool for financial advisors;

FIGS. 8a and 8b are exemplary illustrations of an individual financial advisor data portion of a data input template for use with a practice management analysis tool for financial advisors;

FIG. 9 is an exemplary flowchart of a method for generating a series of reports for use with a practice management analysis tool for financial advisors; and

FIGS. 10, 11, and 12 are exemplary illustrations of reports for use with a practice management analysis tool for financial advisors.

### DETAILED DESCRIPTION

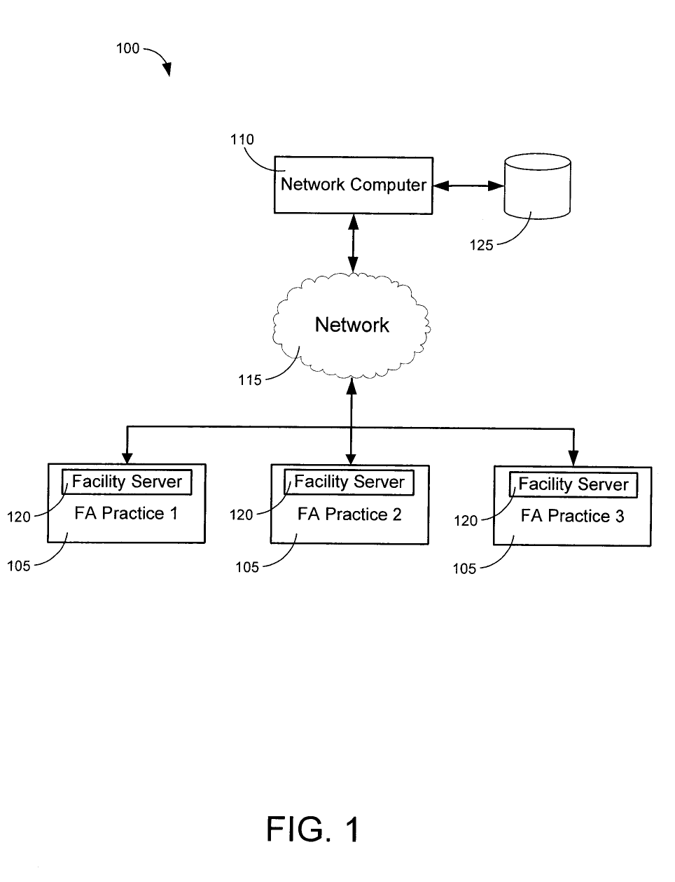

FIG. 1 illustrates an embodiment of a data network 100 including a first group of financial advisor practices 105 operatively coupled to a network computer 110 via a network 115. While the following description generally relates to benchmarking analysis of financial services businesses, the techniques described may be equally applied to other situations and other industries, for example, the marketing of luxury goods, a government analysis of regional taxation, and other market analyses. The plurality of practices 105 may be located, by way of example rather than limitation, in separate geographic locations from each other, in different areas of the same city, or in different states. The network 115 may be provided using a wide variety of techniques well known to those skilled in the art for the transfer of electronic data. For example, the network 115 may comprise dedicated access lines, plain ordinary telephone lines, satellite links, combinations of these, etc. Additionally, the network 115 may include a plurality of network computers or server computers (not shown), each of which may be operatively interconnected in a known, secure or unsecure manner. Where the network 115 comprises the Internet, data communication may take place over the network 115 via an Internet communication protocol.

The network computer 110 may be a server computer of the type commonly employed in networking solutions. The network computer 110 may be used to accumulate, analyze, and download financial advisor practice data. For example, the network computer 110 may periodically receive data from each of the practices 105 related to productivity and growth, expenses, staffing and profitability, and financial advisor productivity and compensation. The network computer 110 may also be a personal computer at which a financial advisor, financial services company representative, management personnel, or other user may access and view information served from other network computers or servers at the practices 105. For example, the practices 105 may include one or more facility servers 120 that may be utilized to store information for a plurality of advisors, clients, or other practice-related information. Additionally, the network computer 110 may be in communication with one or more data repositories 125 that may store financial advisor practice and performance data sent by the one or more practices 105.

Although the data network 100 is shown to include one network computer 110 and three practices 105, it should be understood that different numbers of computers and practices may be utilized. For example, the network 100 may include a plurality of network computers 110 and any number of practices 105, all of which may be interconnected via the network 115. According to the disclosed example, this configuration may provide several advantages, such as, for example, enabling near real time uploads and downloads of information as well as periodic uploads and downloads of information. This provides for a primary backup of all the information generated in the process of analyzing and comparing financial advisor practices.

The computer 110 may be connected to a network, including local area networks (LANs), wide area networks (WANs), portions of the Internet such as a private Internet, a secure Internet, a value-added network, or a virtual private network. Suitable network computers 110 may also include personal computers, laptops, workstations, disconnectable mobile computers, mainframes, information appliances, personal digital assistants, and other handheld and/or embedded processing systems. The signal lines that support communications links to a computer 110 may include twisted pair, coaxial, or optical fiber cables, telephone lines, satellites, microwave relays, modulated AC power lines, and other data transmission “wires” known to those of skill in the art. Further, signals may be transferred wirelessly through a wireless network or wireless LAN (WLAN) using any suitable wireless transmission protocol, such as the IEEE series of 802.x standards. Although particular individual and network computer systems and components are shown, those of skill in the art of digital information distribution will appreciate that the present invention also works with a variety of other networks and computers.

The computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computer 110. Communication media typically embodies computer readable instructions, data structures, program modules or other data and may be in a modulated data signal such as a carrier wave or other transport mechanism, but generally includes any information delivery media. The term “modulated data signal” means a signal that has one or more of its characteristics set, changed, or transformed in such a manner as to encode otherwise concrete information in the signal. By way of example, and not limitation, communication media includes wired media such as a wired network or direct-wired connection, and wireless media such as acoustic, RF, infrared and other wireless media. Combinations of any of the above should also be included within the scope of computer readable media and may optionally be secured using any form of encryption technology known to a person having skill in the art of computer science.

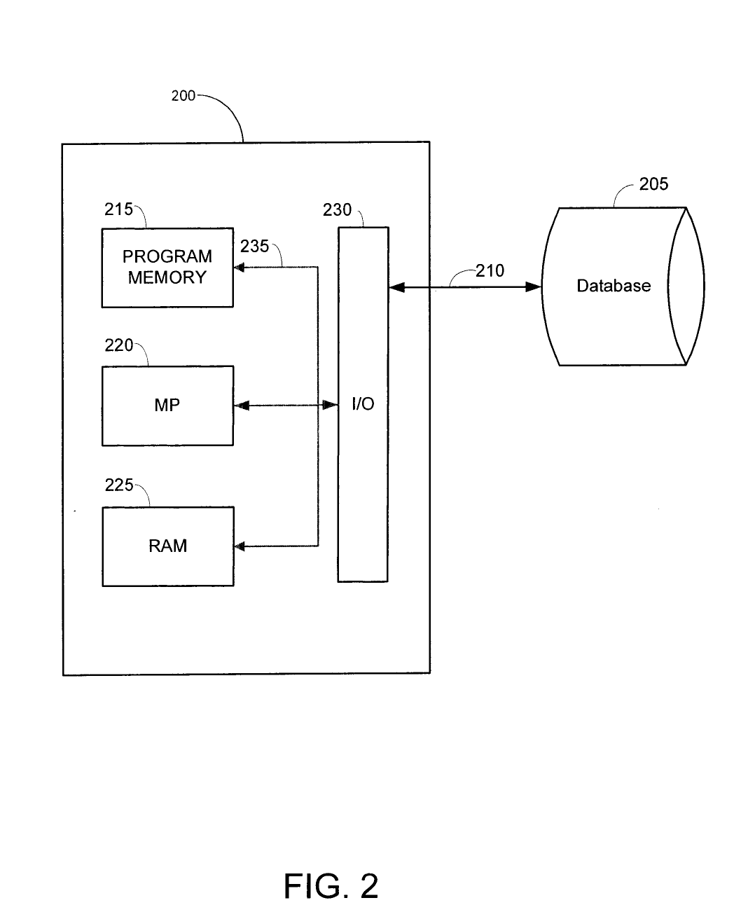

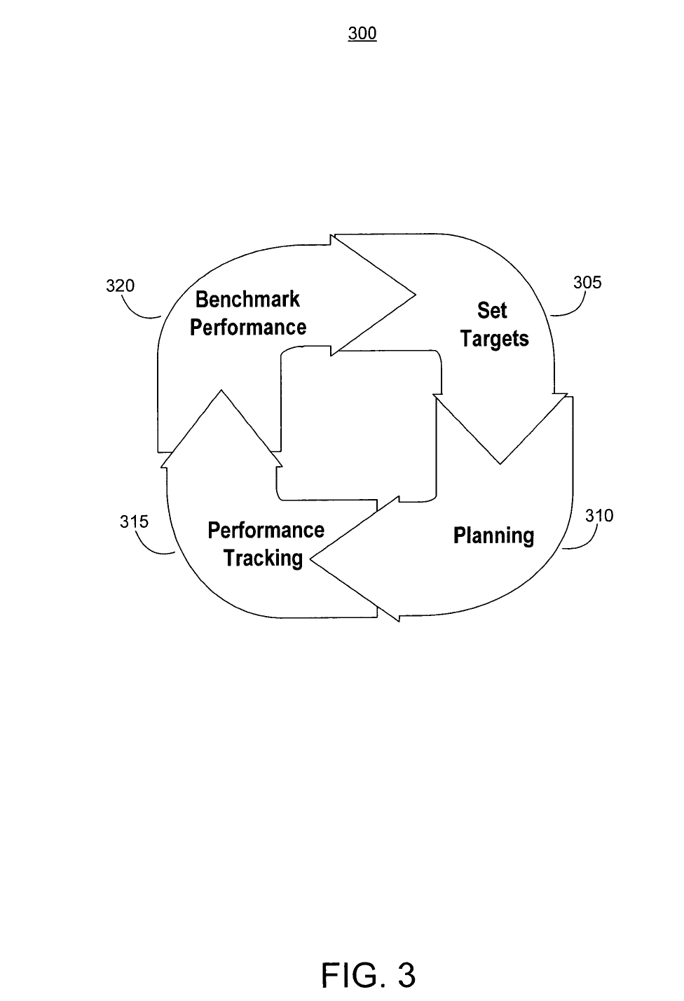

FIG. 2 is a schematic diagram of possible embodiments of the network computer 110 shown in FIG. 1. The network computer 110 may have a controller 200 that is operatively connected to a data repository 205 via a link 210. It should be noted that, while not shown, additional databases may be linked to the controller 200 in a known manner. Further, any communication with the data repository may be secure. In some embodiments, communication with the data repository is encrypted.

The controller 200 may include a program memory 215, a microcontroller or a microprocessor (MP) 220, a random-access memory (RAM) 225, and an input/output (I/O) circuit 230, all of which may be interconnected via an address/data bus 235. It should be appreciated that although only one microprocessor 220 is shown, the controller 200 may include multiple microprocessors 220. Similarly, the memory of the controller 200 may include multiple RAMs 225 and multiple program memories 215. Although the I/O circuit 230 is shown as a single block, it should be appreciated that the I/O circuit 230 may include a number of different types of I/O circuits. The RAM(s) 225 and program memories 215 may be implemented as semiconductor memories, magnetically readable memories, and/or optically readable memories, for example.

The methods illustrated in the figures and described below may be implemented on a variety of wired and wireless networks and connections. Further, any action associated with the blocks described below and illustrated in the figures may be performed in any order, or at any time during the illustrated methods' execution. Much of the inventive functionality and many of the inventive principles are best implemented with or in software programs or instructions and integrated circuits such as application specific integrated circuits. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and integrated circuits with minimal experimentation. Therefore, in the interest of brevity and minimization of any risk of obscuring the principles and concepts in accordance to the present invention, further discussion of such software and integrated circuits, if any, will be limited to the essentials with respect to the principles and concepts of the disclosed examples.

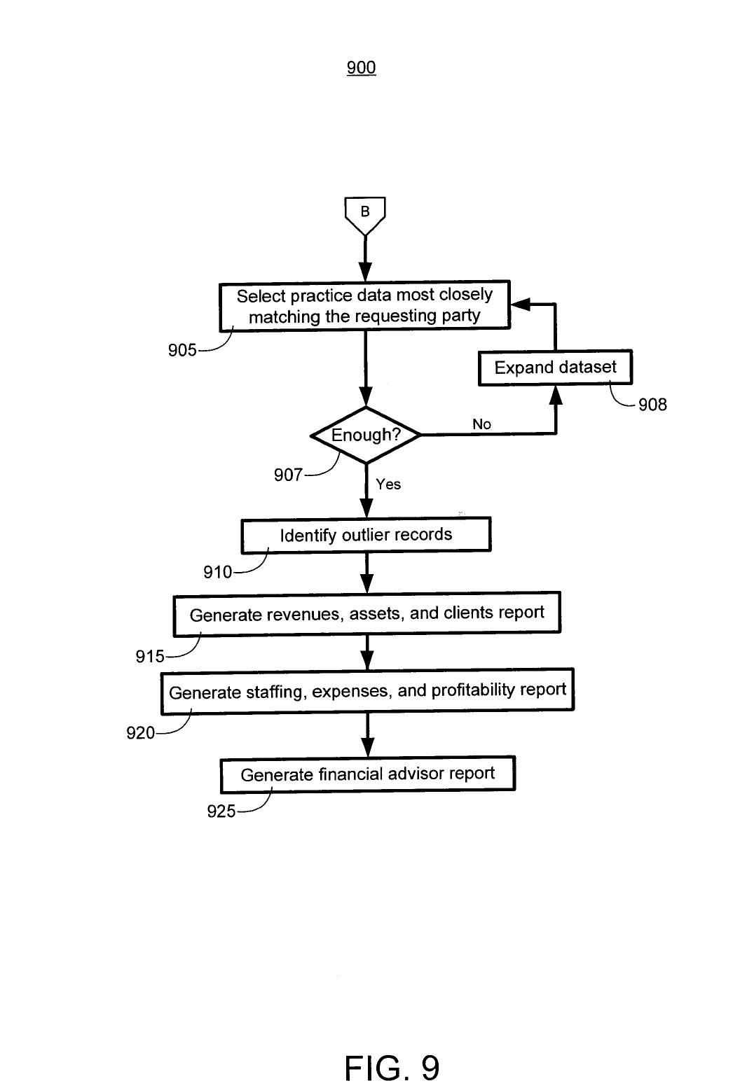

With reference to FIG. 3, a method 300 may generally describe a process for implementing and improving a financial services business strategy. In some embodiments, a practice 105 may implement a plan for business improvement involving a number of steps in a cyclical process. For example, the method 300 may be similar to a financial services practice's 105 strategy for a client's wealth management. At block 305, the practice 105 may set targets. For example, the practice may desire to improve or increase profits of its clients by a percent or it may desire to generate an amount of revenue over a period of time. In some embodiments, the practice 105 utilizes any or all of the reports described in relation to the methods set forth below. At block 310, the practice 105 may plan for the targets set in relation to block 305. In some embodiments, the practice 105 implements a number of actions to reach the targets. For example, the practice 105 may hire or fire a number of its staff to reach a target or allocate more resources toward attaining a target. At block 315, the practice may desire to track its performance. In some embodiments, the practice 105 collects and analyzes any data related to the targets of block 305 and the plans implemented at block 310 to track performance. At block 320, the practice 105 may benchmark its performance against other practices. In some embodiments, the practice compares its performance against a relevant market containing a statistically significant number of data points, for example, thirty or more financial services corporations, practices, or advisors, that are operationally similar. The term “relevant market” is more fully explained below in relation to FIG. 9.

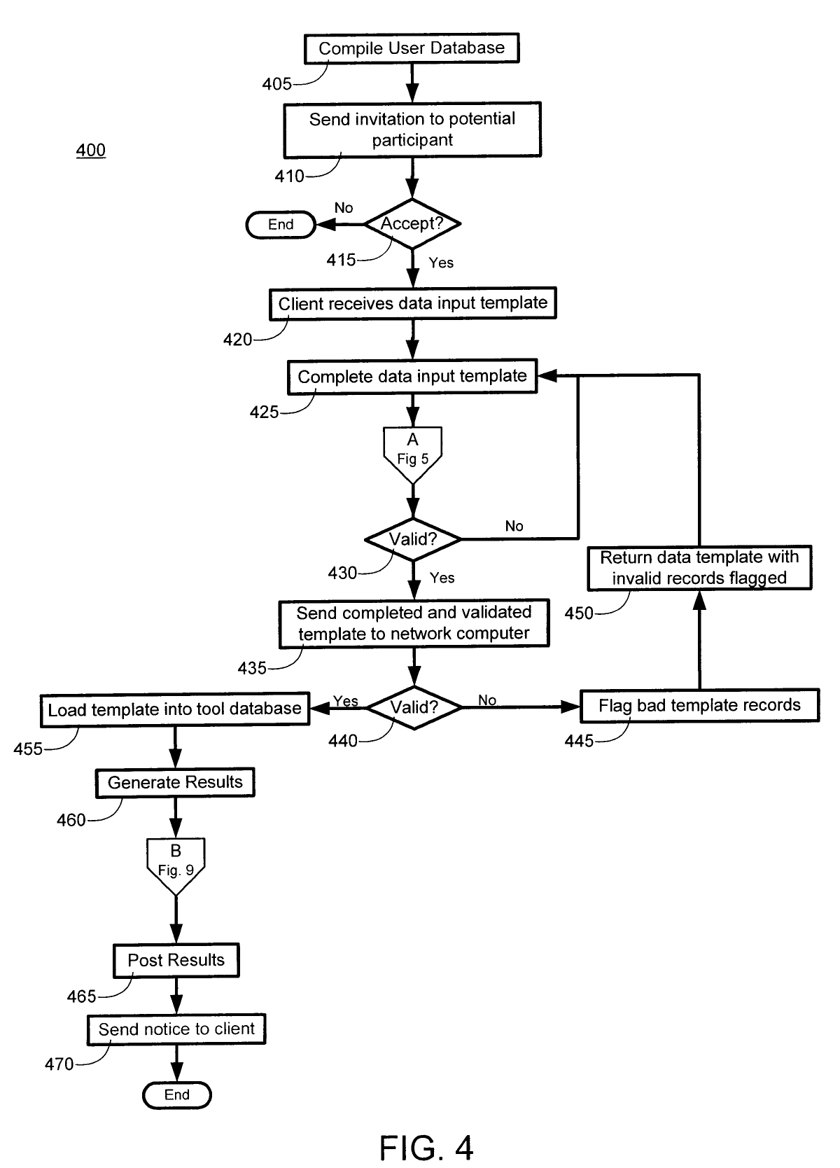

FIG. 4 illustrates and describes a method 400 for benchmarking a plurality of financial advisor practices as part of a business planning process similar to that described in relation to FIG. 3. However, the method 400 may be modified for any sort of benchmarking analysis including the marketing of luxury goods, a government study of area taxation, or any market analysis wherein a business would benefit from comparison to similar businesses. For example, to “benchmark” or compare a financial services business against other, similar financial services businesses, the method 400 may collect and analyze data from a plurality of sources including individual and corporate financial advisors' practices referenced against meaningful demographic and geographic data. In general, financial advisors may submit relevant performance data to a system 100 implementing the method 400 that may provide statistics and other relevant information to effectively compare various aspects of the practices to other, relevant markets. In some embodiments, the system 100 provides a periodic, customized report comparing a particular practice against other practices in relevant markets. Further, an industry trend report may summarize industry performance and compensation, and provide larger corporate financial advisors with information that may be relevant to large regional or national organizations. In further embodiments, a financial advisor practice may commission customized analyses and follow-on research to address organization-specific issues that may have been revealed by the previous performance reports.

At block 405, the method 400 may compile a user database from financial advisors, organizations, or other requesters. For example, a user database may include contact information for a number of individual financial advisors and corporate financial services practices. In some embodiments, the database includes a contact name, address, telephone number, e-mail address, or any other identifying information related to an individual financial advisor and a financial services practice. Additionally, the database may include relevant characteristics to target a desired category of advisor or practice. For example, a region, the type of services offered, past performance data, or any other characteristics may allow the method 400 to identify a group of entries with a common feature to create a relevant market, as described below in relation to FIG. 9.

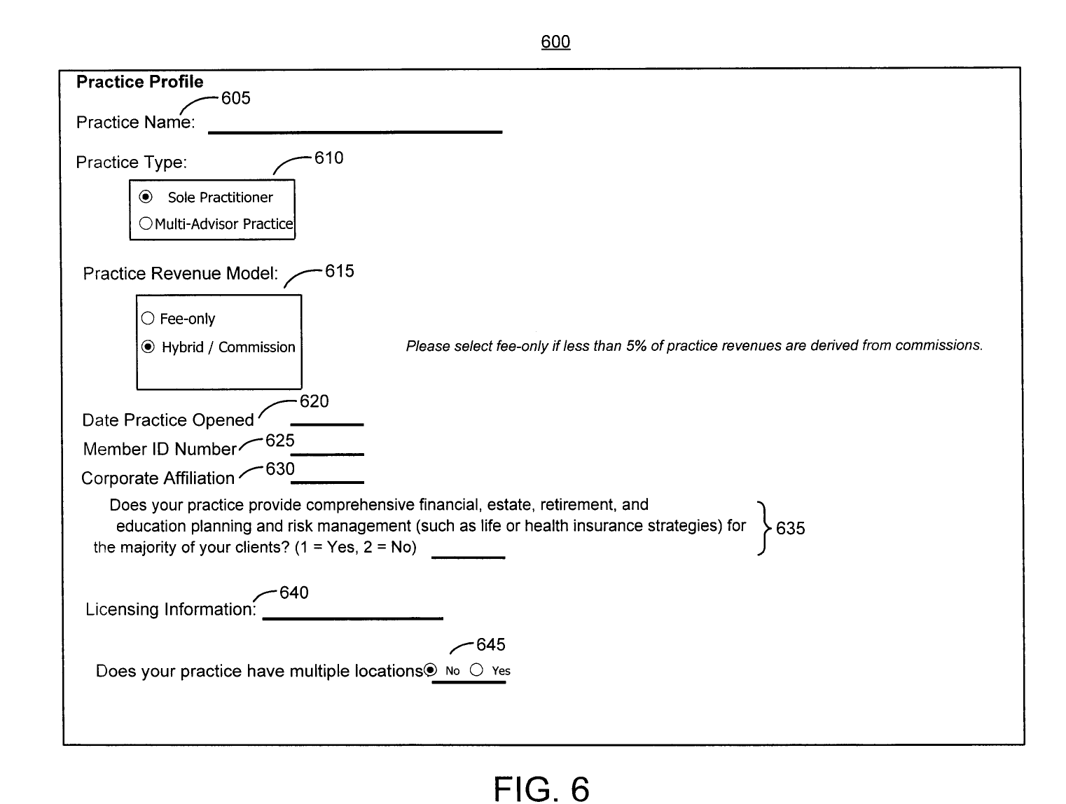

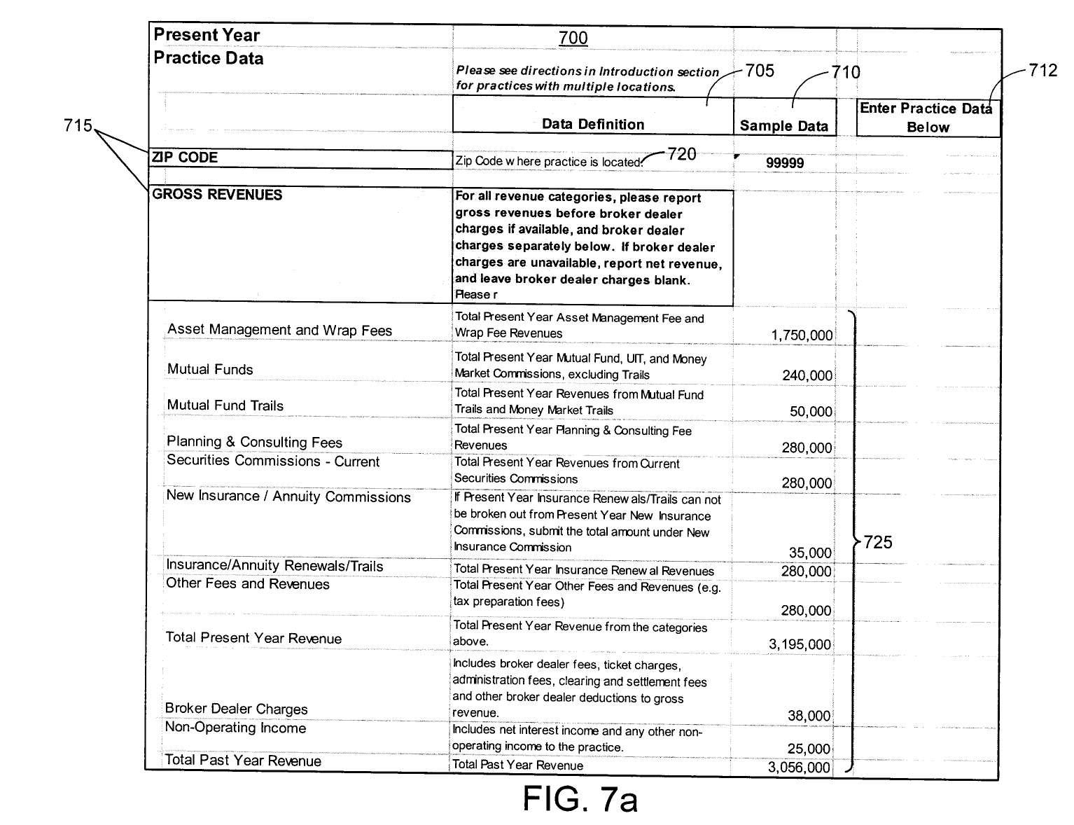

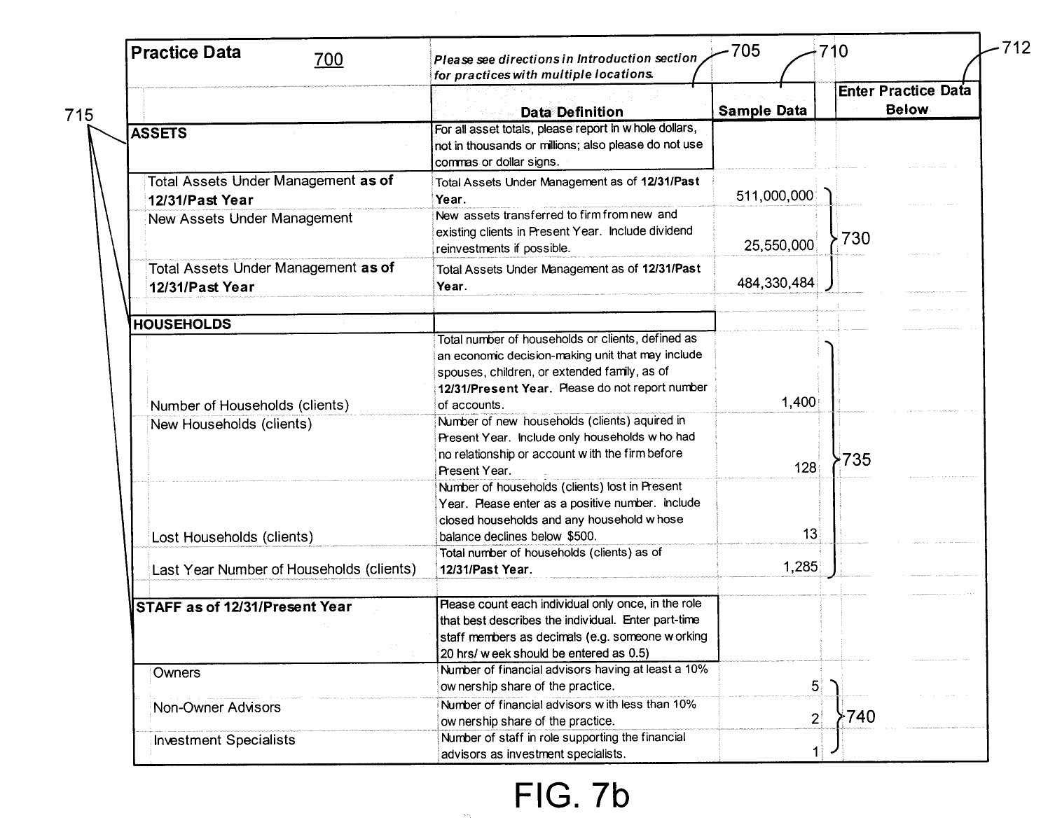

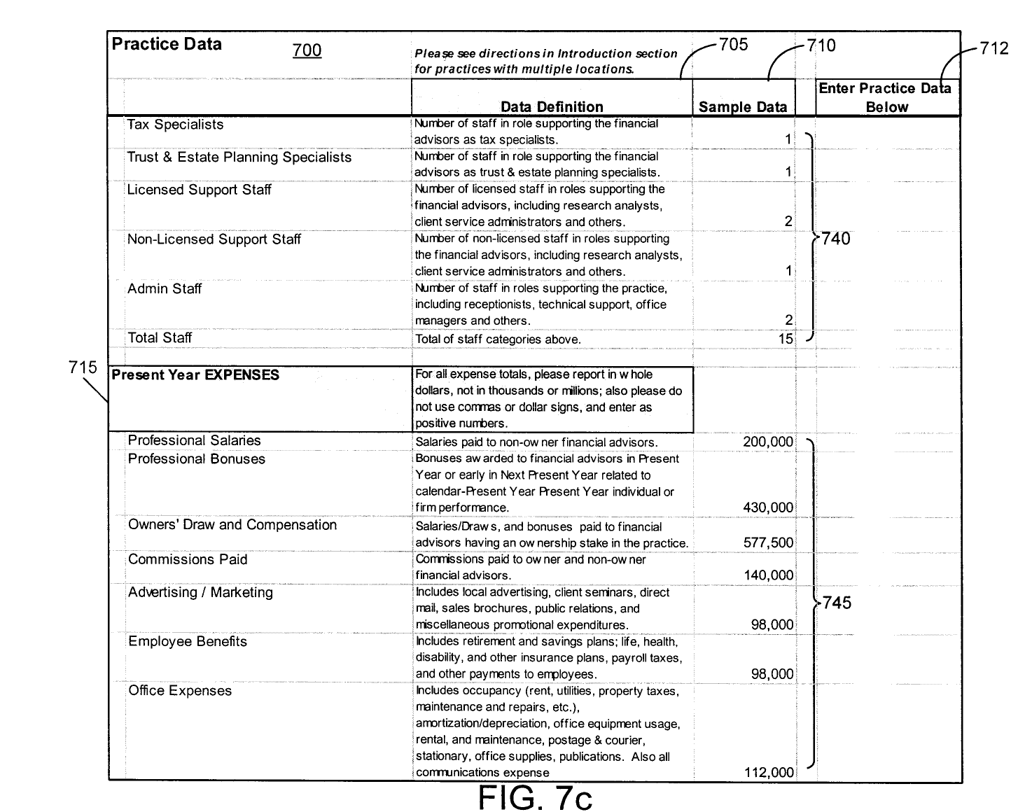

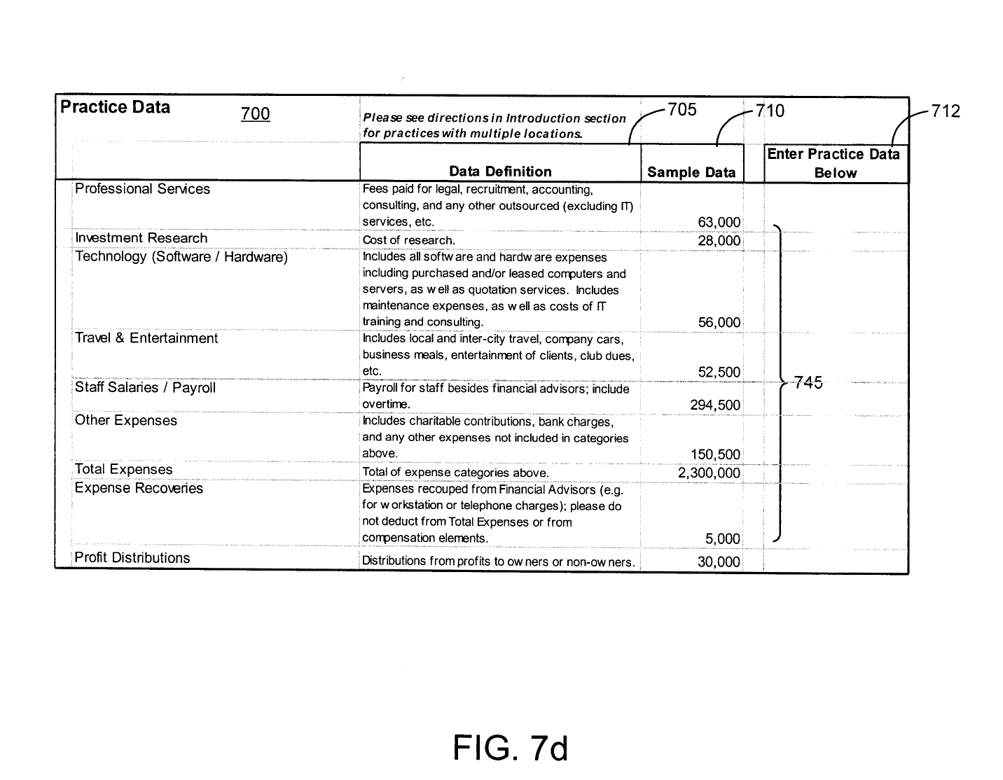

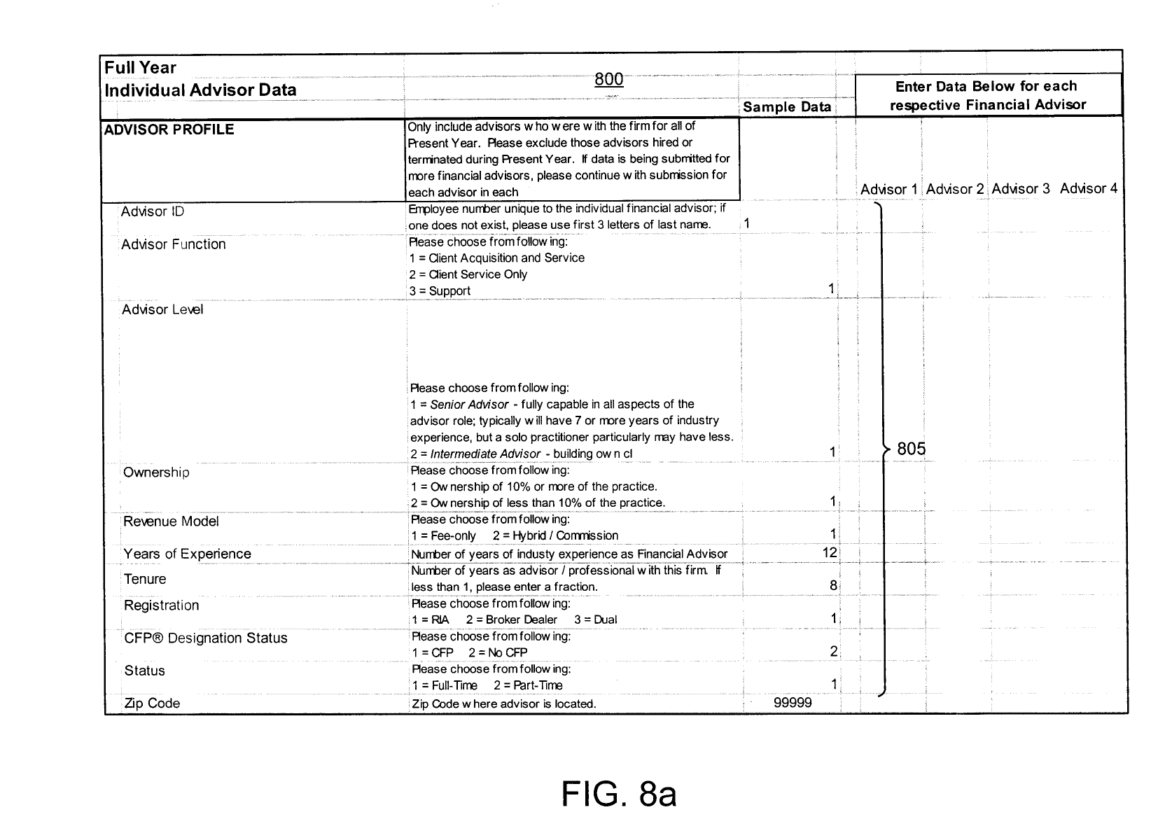

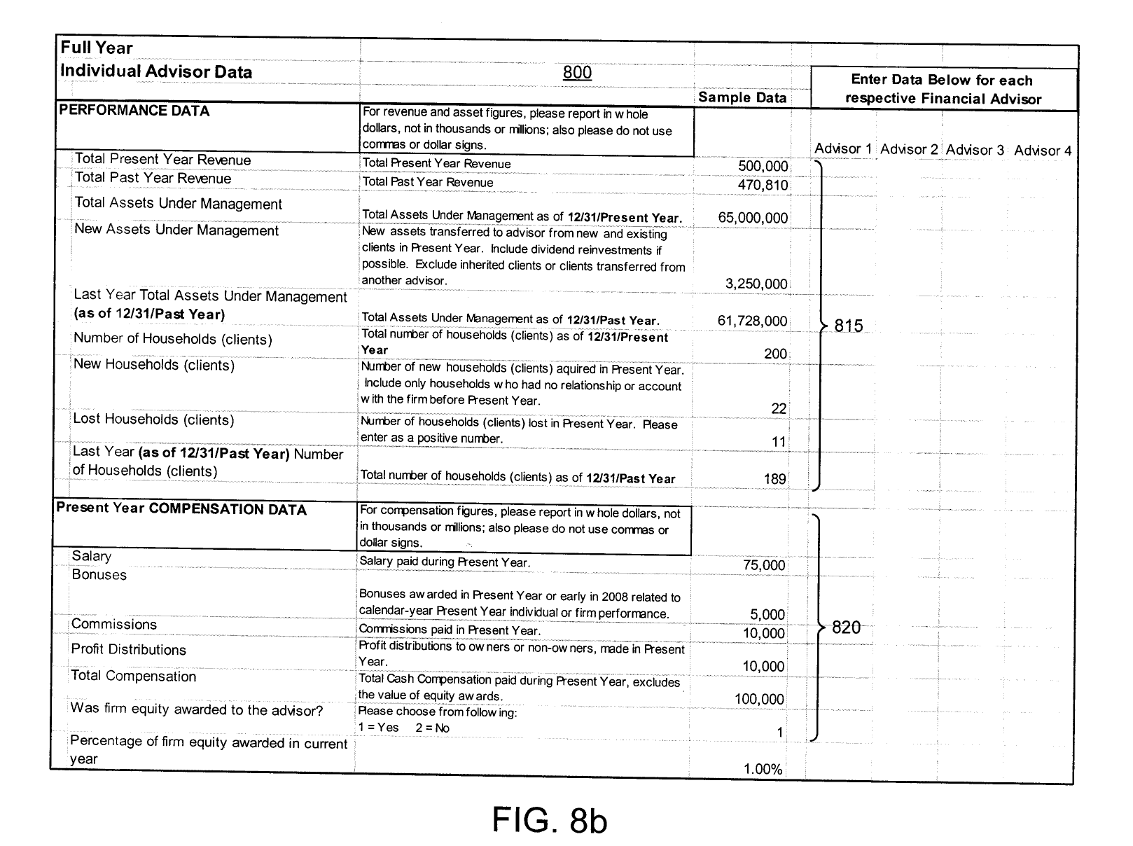

At block 410, the method 400 may invite any number of users described at block 405. In some embodiments, the method 400 generates and sends an e-mail to any number of the potential users. If, at block 415, a financial advisor or financial services company does not accept the invitation, the method may end. If, at block 415, an advisor or company accepts the invitation, then, at block 420, the method 400 may generate and send one or more data input template(s) 600 (FIG. 6), 700 (FIG. 7), 800 (FIG. 8) to the user at block 425. Alternatively, if an advisor or company accepts the invitation at block 415, then the method may direct a user to a website. For example, accepting the invitation at block 415 may cause the method 400 to generate an e-mail including direction data (e.g., a hyperlink, an Internet address, an e-mail address, a physical address, a phone number, or other direction information). In some embodiments, a hyperlink may direct a user to a Web page that integrates any number of Web pages using Asynchronous JavaScript and XML (AJAX) methods. The Web page may appear more responsive than a Non-AJAX page by exchanging small amounts of data with the computer 110 so that the entire page does not have to be reloaded each time the user makes a change or requests further data. Further, the AJAX page may allow a user to interact with a single page rather than a plurality of pages and include additional coding to complete asynchronous communication with the computer 110. The AJAX page may also include Active Server Page (ASP) modules to dynamically create Web pages for various functions (e.g., log in, log in creation, automated log in assistance, progress updating and querying, registration processing, downloading a data input template 600, 700, 800, uploading the template(s), etc.).

At block 425, a financial advisor, financial services corporation, or other user may complete the data input template 600, 700, 800. In some embodiments, the financial advisor or other user fills in any number of data input template fields with information that indicates individual or practice performance metrics. For example, the data input template(s) may request data related to an individual financial advisor's or a financial service firm's compensation, sales, or productivity. In some embodiments, completed data input template(s) 600, 700, 800 include any individual or practice data related to the advisor's or practice's productivity and growth, profitability, and pay. As explained below, in some embodiments, the data entered into the template(s) 600, 700, 800 may be used as a basis for relevant market comparison of individual financial advisors and/or financial services firms to similar advisors and firms. In other words, as more financial services corporations, practices, and advisors complete one or more of the templates 600, 700, 800, the method 400 may develop a “global dataset” that includes numerous business and individual profiles for relevant market comparison.

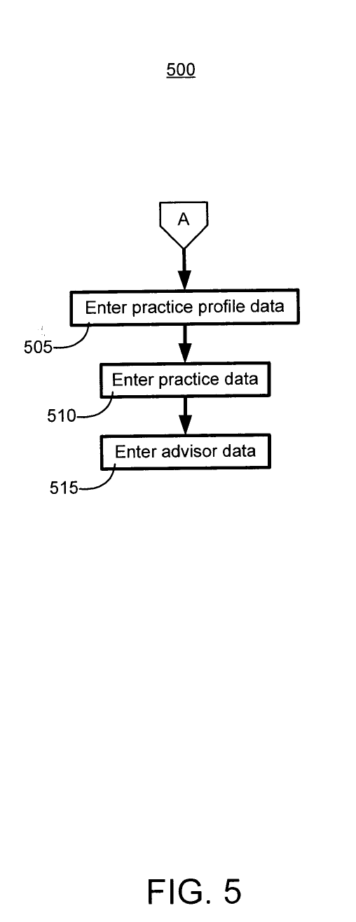

With reference to FIGS. 5, 6, 7a-d, 8a-b, a data input template 600, 700, 800 may be any type of instrument that may facilitate gathering relevant operational and performance data from businesses for relevant market comparison. For example, the data input template 600, 700, 800 may be a survey that presents any number of questions to a financial advisor or other user for gathering data related to the practice or the advisor's individual performance. Further, the data input template 600, 700, 800 may be a spreadsheet file including a number of easily-identifiable metrics that a financial advisor, corporate representative, or other user may gather and input into the template. In some embodiments, the data input template 600, 700, 800 is an Excel® spreadsheet as produced by the Microsoft Corporation of Redmond, Wash., and includes headings and other information to guide the user to enter data related to his or her practice.

Referring to FIG. 5, a method 500 may describe the steps a user may take to complete the data input template(s) 600, 700, 800. At block 505, the user may enter practice profile data 600 (FIG. 6) into the template. For example, the practice profile data may be any information that generally describes operational and non-operational characteristics of a user's practice. In some embodiments, the profile data 600 includes a practice name 605, a practice type 610 (e.g., sole practitioner, multi-advisor practice, or other information), a practice revenue model 615 (e.g., a fee only, hybrid-commission, or other model), a date the practice opened 620, a membership ID number 625, a corporate affiliation 630, an identification of financial, estate, retirement, education planning, and risk management strategy for the user's clients 635, professional and practice licensing information 640, and an indication of whether the practice has multiple locations 645. Of course, many other characteristics may be relevant to a practice's profile and may be included in the data 600. These might include such features as a region of the practice's client base or location, an average client category (e.g., high net worth, low-risk, etc.), and other financial services specific characteristics.

At block 510, the method 500 may permit the user to enter further practice data 700 (FIG. 7a-d). In some embodiments, the data includes performance data 700 that generally relates to the overall operation and performance of the user's practice. For example, the data may include a practice location and staffing data as well as asset, revenue, and expense data for the user's subject practice. To facilitate a user's entry of a practice's operation and performance data, a data definition 705, sample data 710, an area to enter the data 712, and category titles 715 may be included in a practice operation and performance data template 700. For example, the categories 715 may include location information 720 (e.g., a zip code, address, or any other location information), gross revenue data 725 (e.g., asset management and wrap fees, mutual funds, mutual fund trails, planning and consulting fees, securities commissions-current, new insurance/annuity commissions, insurance/annuity renewals/trails, other fees and revenues, total present-year revenue, broker dealer charges, non-operating income, total past year income, average client portfolio type, etc.), assets 730 (FIG. 7b, e.g., total assets under management, new assets under management, last year total assets under management), household data 735 (e.g., number of client households, new client households, lost households, last year number of households, etc.), staff data 740 (e.g., a number of owners, non-owner advisors, investment specialists, —FIG. 7c—tax specialists, trust and estate planning specialists, licensed support staff, non-licensed support staff, admin staff, total staff, etc.), and present year expenses 745 (FIG. 7c, e.g., professional salaries, professional bonuses, owner's draw or base compensation, commissions paid, advertising and marketing, employee benefits, office expenses, —FIG. 7d—professional services, investment research, technology, travel and entertainment, staff salaries, other expenses, total expenses, expense recoveries, profit distributions, etc.). Of course, there are many other types of data that may comprise practice operation and performance data and may be entered as part of block 510.

At block 515, the method 500 may permit the user to enter individual advisor data 800 (FIG. 8a-b). In some embodiments, categories of individual advisor data 800 may include profile data 805 (FIG. 8a) (e.g., an advisor ID, function, level, ownership status, revenue model, years of experience, tenure, registration, certifications, Certified Financial Planner (CFP®) status, any other financial services professional designations, employment status, zip code, etc.), performance data 810 (FIG. 8b, e.g., total revenue, last year total revenue, total assets under management, new assets under management, last year total assets under management, number of client households, new client households, lost households, last year number of households, etc.), compensation data 820 (e.g., salary, bonuses, commissions, total cash compensation, profit distributions, an indication of whether firm equity was offered to the advisor and, if so, what percent in the current year, etc.), and any other advisor data.

Referring, again, to FIG. 4, at block 430, the completed template(s) 600, 700, 800 may be checked for validity. For example, when the data input template(s) 600, 700, 800 are sent to a user at block 420, the template may be sent with or include computer executable code for checking the validity of the completed template. The validity-checking code may determine if a number of required fields within the template are not null, include values that are appropriate for the parameter requested, or any other form of validity check on the data within the input template(s) 600, 700, 800 or the integrity of the templates themselves. Examples of validity checks performed by the method 400 in relation to block 430 are presented below in Appendix 1: Validity Checks. The validity checks of Appendix 1 are exemplary and may be modified to suit non-financial services practice data, different ranges of values, and different acceptable entries for the data input template 600, 700, 800, or other types of templates (e.g., luxury goods marketing, government study for taxation adjustment, or market analyses).

If, at block 430, the computer 110 determines that the data within the template(s) 600, 700, 800 is not valid, the method 400 returns to block 425 to allow a user to re-enter the information, complete the template(s) 600, 700, 800, or correct the validity errors. If, at block 430, the computer 110 determines that the template(s) 600, 700, 800 are valid, at block 435, the method may send the completed and valid template(s) 600, 700, 800 to a network computer 110. Receipt of the template(s) 600, 700, 800 at the network computer 110 may also begin an invoicing process whereby the method 400 may send an invoice to the user.

At block 440, upon receipt of the template 600, 700, 800, the network computer 110 may execute another validity check. For example, the computer 110 may perform a series of validity checks that are similar to the checks performed in relation block 430. In some embodiments, the validity checks include a number of General Data Validations, Practice Data Validations, and Advisor Data Validations. An exemplary listing of validations associated with block 430 or 440 may be found below in Appendix 1. Of course, other validation checks may be included to ensure the integrity of the data and its suitability as a member of a relevant market.

If, at block 440, the computer 110 determines that the received data template(s) 600, 700, 800 is/are not valid, at block 445, the computer 110 may modify the template(s) 600, 700, 800 to include an indication of the invalid portions. In some embodiments, the computer 110 flags the invalid portions of the template(s) 600, 700, 800 by changing their appearance. For example, the computer 110 may change the font color of an invalid portion to red, include a “flag” or other indication that one or more of the template(s) 600, 700, 800, or a portion of the template is invalid, or any other change that may indicate invalidity. At block 450, the computer 110 returns the flagged template(s) 600, 700, 800 to the user who may correct the indicated deficiencies at block 425.

If, at block 440, the computer 110 determines that the template(s) received at block 435 is/are valid, at block 455, the computer 110 stores them. In some embodiments, the computer 110 loads the template(s) 600, 700, 800 into the data repository 125.

At block 460, the computer 110 may generate benchmarking data. The computer 110 may perform a method 900 (FIG. 9) using the data stored in the data repository 125, 205, data from another source, MSA data, other relevant data, or any combination of data to generate relevant benchmarking results for the financial advisor and practice. In general, the method 900 (FIG. 9) (off-page reference “B” of FIG. 4) may provide analysis in one or more relevant markets for the financial adviser and the practice. In some embodiments, the method 900 may analyze the data from the templates 600, 700, 800, combined with MSA and census data for geographically-based wealth information, to produce a data set that is both statistically significant and geographically proximate to a subject financial services corporation, practice, or advisor, and that allows meaningful comparison between similarly-situated businesses.

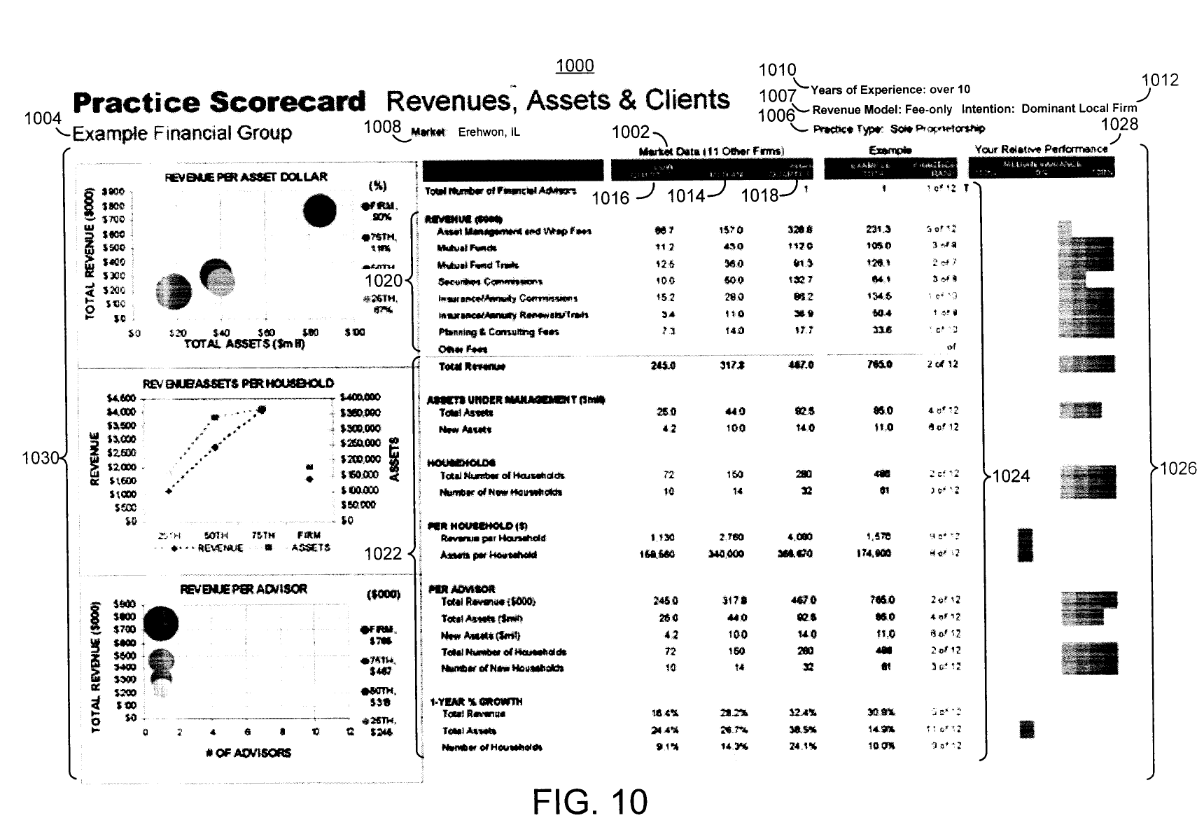

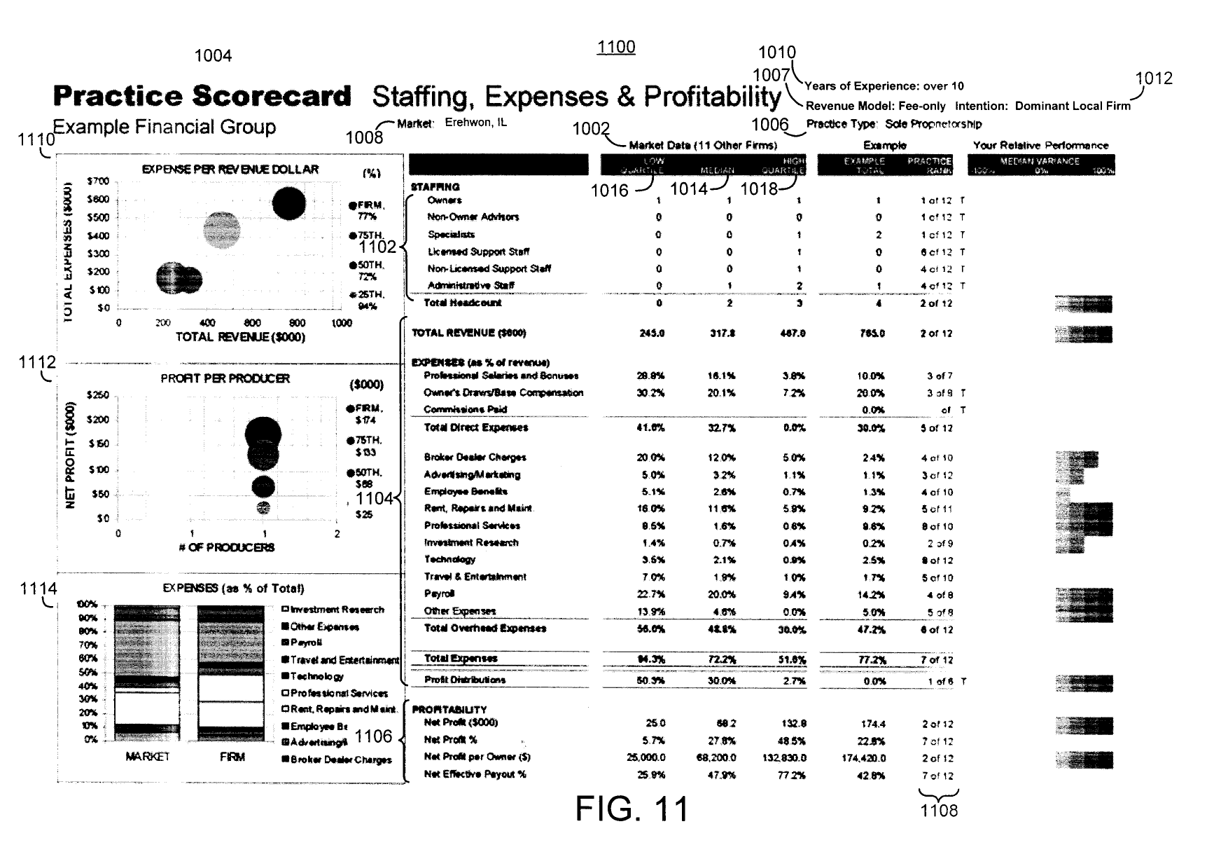

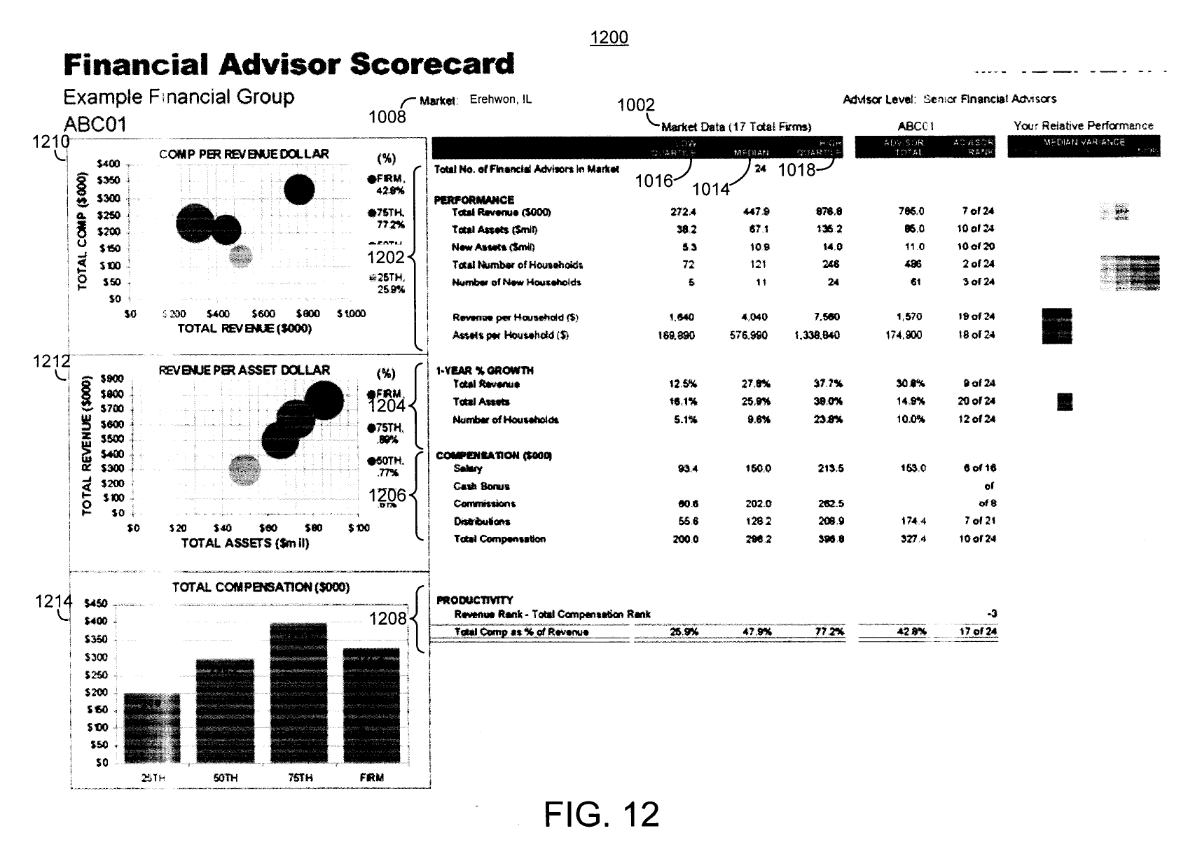

With reference to FIGS. 4 and 9-12, the method 900 (FIG. 9) may generate relevant market comparison reports 1000 (FIG. 10), 1100 (FIG. 11), and 1200 (FIG. 12). At block 905, the method 900 may determine a relevant market dataset by selecting practice data that most closely matches the subject user's practice. With reference to FIG. 10, the relevant market dataset 1002 may include a statistically significant set of data describing other financial services corporations, practices, or advisors that are similarly situated and organized as compared to the subject user's financial services corporation, practice, or individual financial advisor. Instead of merely using data from businesses with proximate location identifiers, the method 900 builds a relevant market dataset 1002 that includes businesses that are most similar based on a variety of factors. For example, while geographically proximate, a practice in the “10021” ZIP code of the Upper East Side of Manhattan in New York City and a practice in the “10451” ZIP code within the Bronx in New York City would not be relevant to each other for comparison due to the likelihood that they will vary widely in terms both practice and advisor data. A more relevant basis for comparison for the practice in the “10021” ZIP code may be practices in the “11977” ZIP code near Westhampton in Long Island, N.Y. where residents in both areas share a similar wealth and income basis, and relevant practices share similar operation data, but the practices are geographically proximate. Of course, other geographic and demographic groupings may be used such as MSAs, area codes, etc., that, coupled with practice operation data, establish relevant markets for comparison.

The relevant market dataset 1002 may be a subset of the global dataset entered by numerous corporations, practices, and advisors in relation to the method 400 (FIG. 4). In some embodiments, the relevant market dataset 1002 is both statistically significant (i.e., includes enough data points for an effective statistical analysis) and meaningful to the subject user 1004. For example, meaningful data points may include data from other financial services corporations, practices, or advisors that are similar in terms of the information entered in relation to FIG. 6, described above (e.g., sole practitioner vs. multi-advisor practice, fee only vs. hybrid/commission, comprehensive services vs. non-comprehensive services, multiple vs. single locations, etc.). The method 900 may also select the relevant market 1002 for a subject user 1004 based on one or more characteristics of ownership 1006 (e.g., sole practitioner or multi-advisor practice), revenue model 1007 (e.g., fee-only or hybrid/commission), geographic location 1008 (e.g., zip code of subject user, a state such as Wisconsin, a region such as the Midwest, a city such as Milwaukee, or other location indicator), the number of years' experience 1010 (e.g., average experience of the advisers within the particular practice), and a practice intention 1012. In some embodiments, the practice intention 1012 corresponds to a goal or aspiration of the subject user 1004, or a target 305 as described above in relation to FIG. 300. In some embodiments, the relevant market dataset 1002 is modified between one or more of the reports 1000, 1100, 1200, as described below.

For example, a profile from the global set wherein a high number of practice characteristics match the subject user's practice may be selected over a profile wherein a low number of characteristics match. Further, similar practices that are geographically proximate to the subject user may be selected over those that are distant. Of course, many other characteristics may also be used to determine latching practice data at block 905.

Optionally, at block 905, the subject user 1004 requesting one or more of the reports 1000, 1100, 1200 may select one or more of the factors or characteristics 1006, 1008, 1010, 1012 to create a relevant market dataset for comparison against the plurality of practices 105 (FIG. 1). For example, a relevant market dataset may include all financial services practices that include one or more operation characteristics selected by the subject user 1004 that are in common with the subject user's practice. Further, the common characteristic may be one or more of the data records submitted on a data input template 600, 700, 800 (e.g., a revenue model, an ownership type, a practice intent, years of experience, or any other characteristic).

At block 907, if the number of records selected in relation to block 905 is not adequate, then at block 908, the method 900 may expand the data selected in relation to block 905. In some embodiments, at block 908, a number of matching characteristics selected at block 905 is decreased, a location indicator is expanded to include other geographic areas, or the selected characteristics are otherwise modified to increase the number of data points. For example, the method 900 may determine that the data selected at block 905 contains a statistically insignificant number of records. The method 900 may then broaden the subject user's 1004 location indicator (e.g., zip code or other location characteristic) to include proximate markets with similar socio-demographic and economic characteristics. For example, a subject user 1004 in Lawton, Okla. may not have a statistically-acceptable number of relevant, matching practices in his or her geographic location to create the reports 1000, 1100, 1200. At block 908, the method 900 may search the global dataset or other data to discover enough records in similar, though geographically disparate, socio-demographic and economic markets (e.g., Fayetteville, N.C., Manhattan, Kansas, and Clarksville, Tenn., etc.) to increase the relevant market dataset to a statistically significant amount (e.g., more than thirty similar financial service corporations, practices, or advisors).

The subject user 1004 may also rank the importance of any or all of the matching characteristics selected in relation to block 905. For example, when only a very small number of practices match all of the characteristics, a subject user 1004 may place more importance on comparing his or her practice against those with a similar number of years' experience 1010 over a particular geographic area 1008. If, at block 907, the method 900 selected an adequate number of records, then the method 900 continues to block 910.

The method 900 may determine the relevant market dataset 1002 in the manner described above in relation to block 905 to 907, keeping it both meaningful and statistically significant to the subject user's corporation, practice, or advisor. The method 900 may, therefore, accommodate any adviser or practice regardless of geographic location or other unique characteristic. Of course, there may be many other factors that may determine a relevant market 1002 for a subject user 1004.

At block 910, the method 900 may identify profiles from the relevant market dataset 1002 (as determined at block 905 to 907) that are outliers. For example, some profiles in the global dataset or the relevant market dataset may include values that are unacceptably greater or less than a parameter from the data templates 600, 700, 800 of the subject user 1004 (e.g., a value of asset management and wrap fees, a distance away from a location indicator 720, etc.) or outside of value for standard deviation of one of the parameters. For example, a number of the records included in a submitted data input template 600, 700, 800 may lead to errors in a statistical analysis of the data. In some embodiments, the method 900 determines a median value 1014, a low quartile 1016 and a high quartile 1018 for each of the characteristics (e.g., FIG. 7, revenues 725, households 735, expenses 745, etc.) submitted in the data input template 600, 700, 800. Further, all values that are a number of standard deviations or larger from the median value 1014 may be eliminated from further analysis. In a further embodiments, the method 900 may identify and eliminate outliers from the global dataset rather than from the relevant market dataset 1002. Of course, other methods may also be applied to the relevant data set 1002 to ensure accurate and useful statistical analysis.

At block 915 to 925, the method 900 may generate one or more reports to compare the subject user's practice against relevant market data. The reports described herein may be benchmarking reports describing a particular practice 105 in comparison to a plurality of similar practices 105. In some embodiments, the computer 110 benchmarks a practice in several areas and produces corresponding reports: 1) a “Revenues, Assets, and Clients” report 1000 (FIG. 10) that may be a representation of the practice productivity and growth, 2) a “Staffing, Expenses, and Profitability” report 1100 (FIG. 11) that may be a representation of practice expenses, staffing, and profitability, and 3) an “Individual Financial Advisor Data” report 1200 (FIG. 12). To generate the reports, the method 900 may execute one or more calculations. For example, the calculations represented in Appendix 2: Report Calculations are examples of possible calculations to generate the reports 1000, 1100, 1200. Of course, many other types of reports may be generated utilizing the data collected in relation to the method 400 or using any combination of the method 400 data or third party data. For example, a report incorporating third party data, such as a market trends summary, may also be used by a practice manager in benchmarking.

Each report 1000, 1100, 1200, may present data that the method 900 customizes for the client. In some embodiments, the computer 110 generates the reports 1000, 1100, 1200, using the global dataset. For example, as previously described in relation to FIG. 4, the data may be collected from a variety of financial services practices and stored in the data repository 205 or from any number of third party sources such as any public world financial index or any private financial analysis service. The data may be any number of records describing any characteristic of an individual financial advisor, a financial planning practice, or other financial services-related information. As previously described, the computer 110 may collect the data as a block of the method 400 in a data input template 600, 700, 800. The collected data may originate from peers of the subject user for which the reports 1000, 1100, 1200 are produced. The method 900 may generate reports 1000, 1100, 1200 using data with characteristics in common to the user. For example, some common characteristics for the reports 1000, 1100, 1200 may include a customer base from similar geographic markets, levels of advisor expertise, years of experience in the financial services industry, time in the market, and adviser or practice intentions. In some embodiments, a financial advisor or practice desires performance benchmarks by the number of years that similar competitors have provided service in the same or similar geographic area. The method 900 may generate reports 1000, 1100, 1200 using data that matches the desired comparison basis. Other embodiments may include benchmarking and comparisons involving any number of bases. For example, such benchmarking factors could include similar experience levels, the financial advisor's or practice's client base, client demographics, advisor or practice strategy or intention, business goals, and other factors.

At block 915, the method 900 may generate a report 1000 comparing the subject user's 1004 revenue, asset, and client data and the relevant market sample 1002 data. As previously discussed, the Revenue, Asset, and Client report 1000 may allow the subject user 1004 to compare the practice's mix of business against the ratios of revenue per advisor and assets per client. Example calculations to arrive at the report 1000 may be found in Appendix 2. The report may include any value of a submitted data input template 600, 700, 800 that includes revenue information 1020 as well as practice productivity and growth information 1022. In some embodiments, the report includes a combination of revenue, assets, clients, revenue and assets per client, revenue, assets, and clients per planner, and one-year percentage growth information.

The Revenue, Asset, and Client report 1000 may also include comparison data. For example, the comparison data may include any form of textual, graphical, audio, or video representations that compare the subject user's 1004 data to the relevant market 1002 data. In some embodiments, the comparisons include a ranking 1024, by each factor of revenue 1020 (e.g., asset management and wrap fees, mutual funds, mutual fund trails, securities commissions, insurance/annuity commissions, insurance/annuity renewals/trails, planning and consulting fees, other fees, and total revenue) and practice productivity and growth 1022 (e.g., assets under management including total assets and new assets, households including total number of households and number of new households, per household information including revenue per household and assets per household, per advisor information including total revenue, total assets, new assets, total number of households, and number of new households, and one-year percentage growth information including total revenue, total assets, and number of households), of the subject user's practice 1004 against the relevant market 1002. In a further embodiment, the comparisons include one or more bar graphs 1026 comparing one or more factors 1020, 1022 and illustrating a statistical evaluation 1028. One example of a statistical evaluation 1028 may be a median variance. In further embodiments, the comparisons include one or more charts 1030 that graphically compare factors of the subject user 1004 against selected quartiles of the same factors from the relevant market 1002. For example, the charts 1030 may represent a comparison of the subject user's 1004 Revenue Per Asset Dollar to the same factor of the low 1016, median 1014, and high 1018 quartiles. Also, the charts 1030 may represent a comparison of Revenue and Assets Per Client between the subject user 1004 and the relevant market 1002. Additionally, the charts 1030 may represent a comparison of Revenue Per Advisor or Planner between the requestor 1004 and the market 1002. Of course, many other types of comparisons may be made with the data submitted in relation to the method 900 that may present useful information for a subject user 1004.

At block 920, the method 900 may generate a Staffing, Expenses, and Profitability report 1100 that may compare the subject user data 1004 against the market data 1002. Example calculations to arrive at the report 1100 may be found in Appendix 2. In some embodiments, the report 1100 permits comparison between the requestor 1004 and relevant market 1002 of mix of staff 1102 (e.g., principals, professionals, support staff, admin staff, etc.) and expense ratios 1104 including direct and overhead expenses (e.g., direct expenses including professional salaries and bonuses, owner's draws/base compensation, commissions paid, and totals, overhead expenses including advertising/marketing, employee benefits, office expenses, professional services, software/hardware, travel and entertainment, other salaries and other overhead, a combination of total direct and total overhead expenses for total expenses, and profit distributions), and profitability 1107 (e.g., net profit in dollars, net profit as a percentage of revenue, net profit per owner, and net effective payout as a percentage of revenue). As with the Revenue, Asset, and Client report 1000, the Staffing, Expenses, and Profitability report 1100 may also include comparison data. In some embodiments, the comparisons include cost control rankings 1108 that indicate, by a lower ranking, an increased proficiency at controlling costs within the practice (e.g., lower expenses as a percentage of revenue). Other comparisons, including graphs, may indicate a course of action for the subject user 1004. For example, a graph representing the costs to revenue ratios 1110 may allow a requestor 1004 to modify spending targets. Comparing profits per advisor 1112 may summarize practice productivity to modify other factors. Also, a graph representing the relative mix of overhead expenses may allow a requestor 1004 to modify expenditures compared to the relevant market.

At block 925, the method 900 may generate a “Financial Advisor” report 1200 that may generally benchmark each advisor in a subject user's practice against others of similar experience or having similar characteristics in the relevant market. Example calculations to arrive at the report 1200 may be found in Appendix 2. The report 1200 may include several sections dedicated to benchmarking financial advisor data. For example, the report 1200 may include portions measuring financial advisor performance 1202 (e.g., total revenue, total assets, new assets, total number of households, number of new households, etc.), advisor growth rates 1204 (e.g., a one-year growth rate including total revenue, total assets, number of households, etc.), compensation 1206 (e.g., salary, cash bonus, commissions distributions, total compensation, etc.), and productivity 1208 (e.g., a revenue rank and/or total compensation rank, total compensation as a percentage of revenue, etc.). The productivity data 1208 may allow a manager to compare each advisor's revenue against their compensation to allow the manager to adjust accordingly. As with the other reports 1000, 1100, the Financial Advisor report 1200 may include comparison data. In some embodiments, graphical comparisons include a summary of the advisor's pay 1210, a measure of the advisor's revenue realization 1212, and a comparison of the advisor's compensation 1214 against the relevant market 1002.

Other embodiments provide reports that may answer a number of advisor and practice strategic and operational planning questions. For example, the reports 1000, 1100, 1200 may provide information regarding winning new clients and assets by identifying what products offer an opportunity for growth in the advisor's practice or how many new clients should the manager target for his or her advisers. In the area of pricing and turning clients into profitable relationships, the reports 1000, 1100, 1200, may identify how much revenue an advisor should be achieving from each client. To raise the productivity of a practice's financial advisors, the reports may identify how a practice manager should set advisor goals that are appropriate for their experience. To attract, motivate, and retain staff for a practice, the reports 1000, 1100, 1200, may identify if financial advisors are appropriately compensated for their performance (compared to other, relevant practices and possibly adjusted for regional differences). Also, to control practice expenses, the reports 1000, 1100, 1200 may identify if the practice is appropriately staffed when size and future goals are considered and where a manager might look for cost-saving opportunities.

The method 900 may generate any number of reports that may be useful to compare a practice 105 against a relevant market. In some embodiments, the reports generated in relation to the method 900 are used to combine and manipulate the data to generate the reports 1000, 1100, 1200, and any other report desired by a financial adviser or practice that uses any combination of the data submitted in the data input templates 600, 700, 800 or third party data. In a further embodiment, a report integrates the reports 1000, 1100, 1200 into a single report that provides a practice manager or independent financial advisor information to identify improvement opportunities, set branch and regional improvement plans, and track progress. For example, a report may include summaries of previously-prioritized performance gaps with available additional information that may provide more detailed views of a variety of performance benchmarks. Examples of some calculations the method 400 may execute to generate the reports are described below in Appendix 2.

By generating comparison data within the reports 1000, 1100, 1200 as described in relation to FIGS. 9 to 12, the subject user 1004 may be able to refine practice growth by setting new goals 305 within numerous categories of the reports 1000, 1100, 1200. Additionally, the reports 1000, 1100, 1200 may aid in planning 310 and performance tracking 315. Generating new reports to benchmark performance 320 may also allow practice managers to reiterate the business planning process 300.

Referring back to FIG. 4, at block 465, the computer 110 may post the results to the user. The results may be any analysis of the data provided in relation to block 425 and may also include third-party data not originating with a practice or advisor. In some embodiments, the results are a series of web-pages or other documents. In other embodiments, the results are integrated into an interactive website that is specifically tailored for a financial services practice manager. For example, managers of the practices 105 may need immediate detailed market information to diagnose their business and identify improvement opportunities. Reports may facilitate manager planning and performance tracking as well as present the information relative to practice opportunities and progress on existing management plans.

At block 470, a notice may be sent to a client from the computer 110 or any other aspect of the network system 100. In some embodiments, the notice is an e-mail that an advisor or practice manager receives that includes a hyperlink to web-based results. As described above, the results may be a Web page(s) or other document that may be viewed for any period of time, a downloadable digital copy of the report, or a requested physical representation of the report that may be sent to the practice or any other entity.

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

### APPENDIX 1

### Validity Checks

Data entry for the data input template 600, 700, 800, may include four worksheets:

1. Introduction

2. Practice Profile

3. Practice Data

4. Advisor Data

Each worksheet may prompt the user to advance to the next worksheet and provide a button to automate the advance. Each worksheet may also provide a button to print the data on the current page.
Data entered by the user may be validated either during the data entry process or when the file is loaded to the database.
While the validity checks below refer to specific blocks of the method 400, the checks are by no means an exclusive or exhaustive listing of all methods of determining data input and uploading validity.

### Validity Checks of Block 430 (FIG. 4)

Practice Data Validations

| | Data Input | Data Validations |
|---|---|---|
| ZIP CODE | | No validations |
| REVENUES | Asset Management and | Stop: Negative values are not allowed. |
| | Wrap Fees | |
| | Mutual Funds | Stop: Negative values are not allowed. |
| | Mutual Fund Trails | Stop: Negative values are not allowed. |
| | Planning & Consulting | Stop: Negative values are not allowed. |
| | Fees | |
| | Securities Commissions - | Stop: Negative values are not allowed. |
| | Current | |
| | New Insurance/ | Stop: Negative values are not allowed. |
| | Annuity Commissions | |
| | Insurance/Annuity | Stop: Negative values are not allowed. |
| | Renewals/Trails | |
| | Other Fees and | Stop: Negative values are not allowed. |
| | Revenues | |
| | Total Revenue | Total Revenue is less than the sum of the Revenue Components or |
| | | greater than 110% of the components. Please confirm that the |
| | | revenue numbers you have entered are correct. Continue? |
| | | Yes/No/Cancel |
| | Non-Operating Income | Stop: Negative values are not allowed. |
| | Last Year Total | Warning: Please confirm that Total Revenue increased or decreased |
| | Revenue | by over 35% between last year and this year. Continue? |
| | | Yes/No/Cancel |
| ASSETS | Total Assets Under | Warning: You have entered an amount that results in a ratio of |
| | Management | revenue as a % of assets outside the expected range of 0.2% to 2%. |
| | | Please confirm that the number you have entered for either assets or |
| | | total revenue is correct. Continue? Yes/No/Cancel |
| | New Assets Under | Stop: Negative values are not allowed. |
| | Management | |
| | Last Year Total | Warning: Please confirm that Total Assets Under Management |
| | Assets Under | increased or decreased by over 35% between last year and this year. |
| | Management | Continue? Yes/No/Cancel |
| HOUSEHOLDS | Number of | Warning: You have entered an amount that results in assets per client |
| | Households | outside of the expected range of $10,000 to $10,000,000. Please |
| | (clients) | confirm that the number you have entered for either clients or assets |
| | | is correct. Continue? Yes/No/Cancel |
| | New Households | Warning: You have entered an amount that results in new assets per |
| | (clients) | new client outside of the expected range of $10,000 to $10,000,000. |
| | | Please confirm that the number you have entered for either new |
| | | clients or new assets is correct. Continue? Yes/No/Cancel |
| | Lost Households | Stop: Negative values are not allowed. |
| | (clients) | |
| | Last Year Number | Warning: Please confirm that the Number of Clients increased or |
| | of Households | decreased by over 35% between last year and this year. Continue? |
| | (clients) | Yes/No/Cancel |
| STAFF as of | Owners | Warning: Please confirm that the practice has no financial advisors |
| Dec. 31, 2006 | | with an ownership stake in the firm. Continue? Yes/No/Cancel |
| | Non-Owner | Warning: You have entered an amount that results in assets per |
| | Advisors | advisor outside of the expected range of $5,000,000 to $100,000,000. |
| | | Please confirm that the number you have entered for either advisors |
| | | or assets is correct. Continue? Yes/No/Cancel |
| | Investment | Stop: Negative values are not allowed. |
| | Specialists | |
| | Tax Specialists | Stop: Negative values are not allowed. |
| | Trust & Estate | Stop: Negative values are not allowed. |
| | Planning | |
| | Specialists | |
| | Licensed Support | Stop: Negative values are not allowed. |
| | Staff | |
| | Non-Licensed | Stop: Negative values are not allowed. |
| | Support Staff | |
| | Admin Staff | Stop: Negative values are not allowed. |
| | Total Staff | Stop: Total Staff cannot be less than the sum of the Staff Categories. |
| 2006 | Professional Salaries | Stop: Negative values are not allowed. |
| EXPENSES | Professional Bonuses | Stop: Negative values are not allowed. |
| | Owners' Draw/Base | Stop: Negative values are not allowed. |
| | Compensation | |
| | Commissions Paid | Stop: Negative values are not allowed. |
| | Advertising/Marketing | Stop: Negative values are not allowed. |
| | Employee Benefits | Stop: Negative values are not allowed. |
| | Office Expenses | Stop: Negative values are not allowed. |
| | Professional Services | Stop: Negative values are not allowed. |
| | Investment Research | Stop: Negative values are not allowed. |
| | Technology (Software/ | Stop: Negative values are not allowed. |
| | Hardware) | |
| | Broker Dealer Charges | Stop: Negative values are not allowed. |
| | Travel & Entertainment | Stop: Negative values are not allowed. |
| | Staff Salaries/Payroll | Stop: Negative values are not allowed. |
| | Other Expenses | Stop: Negative values are not allowed. |
| | Total Expenses | Stop: Total Expenses cannot be less than the sum of the |
| | | Expense Components. |
| | Expense Recoveries | Stop: Negative values are not allowed. |
| | Profit Distributions | Stop: Negative values are not allowed. |

Advisor Data Validations

| | Data Input | Data Validations |
|---|---|---|
| ADVISOR PROFILE | Advisor ID | Stop: Negative values are not allowed. |
| | Advisor Function | Stop: Please choose from the valid entries of 1-3. |
| | Advisor Level | Stop: Please choose from the valid entries of 1-3. |
| | Ownership | Stop: Please choose from the valid entries of 1-2. |
| | Revenue Model | Stop: Please choose from the valid entries of 1-2. |
| | Years of Experience | Stop: Negative values are not allowed. |
| | Tenure | Stop: Negative values are not allowed. |
| | Registration | Stop: Please choose from the valid entries of 1-3. |
| | CFP ® Designation Status | Stop: Please choose from the valid entries of 1-2. |
| | Status | Stop: Please choose from the valid entries of 1-2. |
| | Zip Code | Stop: Zip Codes must be 5 characters long. |
| PERFORMANCE | Total Revenue | Stop: Negative values are not allowed. |
| DATA | Last Year Total | Please confirm that Total Revenue increased or decreased by |
| | Revenue | over 35% between last year and this year. |
| | Total Assets Under | Warning: You have entered an amount that results in a ratio of |
| | Management | revenue as a % of assets outside the expected range of 0.2% to |
| | | 2%. Please confirm that the number you have entered for |
| | | either assets or total revenue is correct. |
| | New Assets Under | Stop: Negative values are not allowed. |
| | Management | |
| | Last Year Total | Warning: Please confirm that Total Assets Under |
| | Assets Under | Management increased or decreased by over 35% between |
| | Management | last year and this year. |
| | Number of | Warning: You have entered an amount that results in assets |
| | Households (clients) | per client outside of the expected range of $10,000 to |
| | | $10,000,000. Please confirm that the number you have |
| | | entered for either clients or assets is correct. |
| | New Households | Warning: You have entered an amount that results in new |
| | (clients) | assets per new client outside of the expected range of $10,000 |
| | | to $10,000,000. Please confirm that the number you have |
| | | entered for either new clients or new assets is correct. |
| | Lost Households | Stop: Negative values are not allowed. |
| | (clients) | |
| | Last Year Number of | Warning: Please confirm that the Number of Clients increased |
| | Households (clients) | or decreased by over 35% between last year and this year. |
| 2006 | Salary | Stop: Negative values are not allowed. |
| COMPENSATION | Bonuses | Stop: Negative values are not allowed. |
| DATA | Commissions | Stop: Negative values are not allowed. |
| | Total Cash | Stop: Total Compensation cannot be less than the sum of the |
| | Compensation | Compensation Components. |
| | Profit Distributions | No Validations. |
| | Was firm equity | Stop: Please choose from the valid entries of 1-2. |
| | awarded to the | |
| | advisor? | |
| | Percentage of firm | No Validations. |
| | equity awarded in | |
| | current year | |

### Validity Checks of Block 440

1) Numeric vs. Character Fields—can't mix the two (error=PR1)
2) No negative numbers in any numeric field (error=NEG)
3) Zip Code (ZIP) must be valid (checked against master look-up table) (error=ZIP)

### Practice Data Validations

1) Total Revenue (R01) must equal sum of revenues by product (R02 through R07) (error=RV1)
2) Last-year Total Revenue (RX1) must be within 25% of this year's Total Revenue (R01) (above or below) (error=RV2)
3) Total Assets (A01) must be greater than New Assets (A02) (error=AS1)
4) Last-year Total Assets (AX1) must be within 25% of this year's Total Assets (A01) (above or below) (error=AS2)
5) Number of Clients (N01) must be greater than New Clients (N02) (error=CL1)
6) Last Year Total Clients (NX1) must be greater than Lost Clients (N03) (error=CL2)
7) Last Year Total Clients (NX1) must be within 25% of this year's Total Clients (N01) (above or below) (error=CL3)
8) Total Staff (SX1) must equal sum of individual Staffing categories (S01 through S04) (error=ST1)
9) Total Expenses (E51) must equal sum of individual expense categories (E01 through E11) (error=EX1)
10) Total Expenses (E51) can't be greater than 95% of Total Revenue (R01) (error=ER1)
11) Total Revenue (R01) can't be less than 0.25% of Total Assets (A01), or greater than 1.5% of Total Assets (error=RA1)
12) Must be valid category codes for the following:

a) Practice Type (I31) must be 1 or 2 (error=PR2)

b) Practice Type II (I??) must be 1-3 (error=PR3)

### Advisor Data Validations

1) Last-year Total Revenue (RX1) must be within 25% of this year's Total Revenue (R01) (above or below) (error=RV2)
2) Total Assets (A01) must be greater than New Assets (A02) (error=AS1)
3) Last-year Total Assets (AX1) must be within 25% of this year's Total Assets (A01) (above or below) (error=AS2)
4) Number of Clients (N01) must be greater than New Clients (N02) (error=CL1)
5) Last Year Total Clients (NX1) must be greater than Lost Clients (N03) (error=CL2)
6) Last Year Total Clients (NX1) must be within 25% of this year's Total Clients (N01) (above or below) (error=CL3)
7) Total Revenue (R01) can't be less than 0.25% of Total Assets (A01), or greater than 1.5% of Total Assets (error=RA1)
8) Total Compensation (C20) must equal sum of individual compensation components (C01-C06) (error=CM1)
9) Total Compensation (C20) can't be greater than 75% of Total Revenue (R01), or less than 10% of Total Revenue (error=CM2)
10) Must be valid category codes for the following:

b. Advisor Level (I12) must be 1-4 (error=FP1)

c. Advisor Type (I??) must be 1-3 (error=FP2)

d. Years of Experience Category (I55) must be 4-9 (error=FP3)

e. Status (I58) must be 1 or 2 (error=FP4)

### APPENDIX 2

### Report Calculations

The following is an example of the calculations that may be performed when generating each of the following reports as described above:

### Revenues, Assets and Clients (FIG. 10)

| | Report Label | Calculation |
|---|---|---|
| 1 | Total Number of Financial | Total no. Financial |
| | Advisors | Advisors, all firms |
| 2 | Asset Management & Wrap Fees | None |
| 3 | Mutual Funds | None |
| 4 | Mutual Fund Trails | None |
| 5 | Securities Commissions | None |
| 6 | Insurance/Annuity Commissions | None |
| 7 | Insurance/Annuity Renewals/Trails | None |
| 8 | Planning & Consulting Fees | None |
| 9 | Other Fees | None |
| 10 | Total Revenue | None |
| 11 | Assets Under Management − Total | None |
| | Assets | |
| 12 | Assets Under Management − New | None |
| | Assets | |
| 13 | Total Number of Households | None |
| 14 | Number of New Households | None |
| 15 | Revenue per Household | Revenue/Total Households |
| 16 | Assets per Household | Assets/Total Households |
| 17 | Total Revenue ($000) (per | None |
| | Advisor) | |
| 18 | Total Assets ($mil) (per Advisor) | None |
| 19 | New Assets ($mil) (per Advisor) | None |
| 20 | Total Number of Households (per | None |
| | Advisor) | |
| 21 | Number of New Households (per | None |
| | Advisor) | |
| 22 | 1-Year % Growth − Total Revenue | (This year Revenue − |
| | | Last Year Revenue)/ |
| | | Last Year Revenue |
| 23 | 1-Year % Growth − Total Assets | (This year Assets − |
| | | Last Year Assets)/ |
| | | Last Year Assets |
| 24 | 1-Year % Growth − Number of | None |
| | Households | |
| Graph 1 | Revenue per Asset Dollar | Revenue/Assets |

### Staffing, Expenses and Profitability (FIG. 11)

| Report Label | Calculation |
|---|---|
| Owners | None |
| Non-Owner Advisors | None |
| Specialists | Investment Specialists + Tax Specialists + |
| | Trust & Estate Planning Specialists |
| Licensed Support Staff | None |
| Non-Licensed Support Staff | None |
| Administrative Staff | None |
| Total Headcount | None |
| Total Revenue ($000) | None |
| Professional Salaries and | None |
| Bonuses | |
| Owner's Draws/Base | None |
| Compensation | |
| Commissions Paid | None |
| Total Direct Expenses | (Prof. Salaries & Bonuses + |
| | Owner's Draws/Base Comp + |
| | Commissions Paid)/Total Revenue |
| Broker Dealer Charges | None |
| Advertising/Marketing | None |
| Employee Benefits | None |
| Rent, Repairs and Maint. | None |
| Professional Services | None |
| Investment Research | None |
| Technology | None |
| Travel & Entertainment | None |
| Payroll | None |
| Other Expenses | None |
| Total Overhead Expenses | (Broker-Dealer Charges + |
| | Advertising-Marketing + Employee |
| | Benefits + Rent, Repairs, Maint + |
| | Prof Services + Investment |
| | Research + Technology + |
| | T & E + Payroll + Other |
| | Expenses)/Total Revenue |
| Total Expenses | Sum of all Expense Categories (i.e. |
| | Total Direct + Total Indirect) |
| Number of Financial Advisors | Totl number of Financial Advisors |

### Financial Advisor Data (FIG. 12)

| Report Label | Calculation |
|---|---|
| Total No. of Financial Advisors in Market | Total of all Fas for all |
| | firms |
| Total Revenue ($000) | None |
| Total Assets ($mil) | None |
| New Assets ($mil) | None |
| Total Number of Households | None |
| Number of New Households | None |
| Revenue per Household | Revenue/Clients |
| Assets per Household | Assets/Clients |
| 1-Year % Growth − Total Revenue | Percent Change This year |
| | Revenue − Last Year |
| | Revenue |
| 1-Year % Growth − Total Assets | Percent Change This year |
| | Assets − Last Year Assets |
| 1-Year % Growth − Number of | None |
| Households) | |
| Salary | None |
| Cash Bonus | None |
| Commissions | None |
| Distributions | None |
| Total Compensation | None |
| Revenue Rank − Total Compensation Rank | Revenue Rank − Total |
| | Comp Rank |
| Total Comp as % of Revenue | Total Comp/Revenue |

What is claimed:

1. A method for benchmarking a business against a relevant market comprising:
compiling a plurality of business profiles for a plurality of businesses, each profile including operation and performance data for each of the plurality of businesses, wherein the operation data includes one or more of a practice type and a revenue model type, and the performance data includes one or more of a location, revenues, assets, and expenses;
selecting a subject business profile from the plurality of business profiles;
selecting a relevant market dataset from the plurality of business profiles, wherein each of the business profiles of the relevant market dataset includes one or more of operation data and performance data that matches the subject business profile; and
comparing the performance data of the subject business profile to the performance data of the relevant market dataset.

2. The method of claim 1, wherein the operation data further includes one or more of a date the business opened, licensing information, a multiple locations indicator, and an indication of whether the business provides comprehensive financial, estate, retirement and education planning and risk management for a majority of clients of the business.

3. The method of claim 2, wherein selecting the relevant market dataset from the plurality of business profiles includes selecting one or more of the operation data or the performance data of the subject business profile, wherein each of the business profiles of the relevant market dataset includes selected data.

4. The method of claim 3, further comprising assigning a weighted value to the selected data, wherein selecting the relevant market dataset from the plurality of business profiles includes selecting the business profile from the global dataset with the highest weighted value assigned to the selected data.

5. The method of claim 1, wherein the location includes one or more of a ZIP code, an area code, a Metropolitan Statistical Area, or an address.

6. The method of claim 1, wherein the practice type includes a sole practitioner type or a multi-advisor type.

7. The method of claim 1, wherein the revenue model type includes fee-only, commission-only, or a combination of fees and commissions.

8. The method of claim 1, wherein the subject business profile corresponds to operation and performance data of one or more of a financial services practice or a financial advisor.

9. The method of claim 1, further comprising determining if the relevant market dataset includes a statistically significant subset of the plurality of business profiles.

10. The method of claim 9, further comprising one or more of decreasing a number of data that matches the subject business profile or expanding the location if the relevant market dataset does not include a statistically significant subset of the plurality of business profiles.

11. A computer system comprising a processor for executing computer executable code, a memory for storing computer executable code and an input/output device, the processor being programmed to execute computer executable code for benchmarking the performance of a subject business against a relevant market of businesses, the computer executable code comprising code for:
compiling contact information for a plurality of businesses;
inviting one or more of the plurality of businesses to participate in a benchmarking analysis;
sending one or more data templates to each of the plurality of businesses that accepts the invitation to participate in the benchmarking analysis, wherein the one or more data templates include a practice profile data template, an operation and performance data template, and an individual advisor data template;
entering data into each of the one or more data templates;
storing the entered data as a global dataset including a business profile for each of the plurality of businesses that accepts the invitation, each profile including operation and performance data from the one or more data templates, wherein the operation data includes one or more of a practice type and a revenue model type, and the performance data includes one or more of a location, revenues, assets, and expenses;
selecting a subject business profile from the global dataset;
selecting a relevant market dataset as a subset of the global dataset, wherein the relevant market dataset includes a statistically significant subset of the global dataset, and each of the business profiles of the relevant market dataset includes one or more of operation and performance data that matches the subject business profile;
comparing the performance data of the subject business profile to the performance data of the relevant market dataset; and
generating one or more benchmarking reports for the subject business profile from the comparison to the relevant market dataset.

12. The computer system of claim 11, wherein the contact information includes one or more of a contact name, address, telephone number, or e-mail address.

13. The computer system of claim 11, wherein the plurality of businesses includes a plurality of financial services practices, design practices, insurance practices, medical practices, dental practices, tax planning services, luxury sales firms, or manufacturing representative practices.

14. The computer system of claim 11, wherein sending one or more data templates to each of the plurality of businesses that accepts the invitation includes one or more of sending an e-mail including a hyperlink to direct the accepting business to a website including the one or more data templates or sending the one or more data templates to the accepting business via e-mail.

15. The computer system of claim 14, wherein the website integrates a plurality of Web pages using Asynchronous JavaScript and XML, each of the plurality of pages including one or more of the data templates.

16. The computer system of claim 11, further comprising code for validating the data entered into each of the one or more data templates.

17. The computer system of claim 11, wherein each of the data templates is an Excel® spreadsheet.

18. The computer system of claim 11, wherein the operation data further includes one or more of a date the business opened, licensing information, a multiple locations indicator, and an indication of whether the business provides comprehensive financial, estate, retirement and education planning and risk management for a majority of clients of the business.

19. The computer system of claim 11, wherein the location includes one or more of a ZIP code, an area code, a Metropolitan Statistical Area, or an address.

20. The computer system of claim 11, wherein the practice type includes a sole practitioner type or a multi-advisor type, the revenue model type includes fee-only, commission-only, or a combination of fees and commissions, and the performance data includes household data, staff data, and past year expenses.

21. The computer system of claim 11, wherein generating one or more benchmarking reports for the subject business profile from the comparison to the relevant market dataset includes statistically analyzing the relevant market dataset to determine statistical values for a low quartile, a median, and a high quartile for the operation and performance data of the relevant market dataset.

22. A computer storage medium comprising computer executable code for benchmarking a financial services business against a relevant market dataset, the benchmarking comprising:
compiling a plurality of financial services business profiles for a plurality of financial services practices, each profile including operation and performance data for each of the plurality of businesses, wherein the operation data includes one or more of a practice type, and a revenue model type, and the performance data includes practice performance data and financial advisor performance data, the practice performance data including one or more of a practice location, revenues, assets, household data, staff data, and past year expenses, and the financial advisor performance data including one or more of advisor revenues, assets under management data, and compensation data;
selecting a subject financial services business profile from the plurality of financial services business profiles;
selecting a relevant market dataset from the plurality of financial services business profiles, wherein the relevant market dataset includes a statistically significant subset of the plurality of financial services business profiles, and each of the financial services business profiles of the relevant market dataset includes one or more of operation data and performance data that matches the subject financial services business profile;
statistically analyzing the relevant market dataset to determine statistical values for a low quartile, a median, and a high quartile for the operation and performance data of the relevant market dataset;
comparing the practice performance data and the operation data of the subject financial services business profile to the determined statistical values of the relevant market dataset to generate a practice benchmark analysis; and
comparing the financial advisor performance data and the operation data of the subject financial services business profile to the determined statistical values of the relevant market dataset to generate a benchmark analysis report.

23. The computer storage medium of claim 22, wherein the operation data further includes a date the financial services business opened, licensing information, a multiple locations indicator, and an indication of whether the financial services business provides comprehensive financial, estate, retirement and education planning and risk management for a majority of clients of the business.

24. The computer storage medium of claim 22, wherein selecting the relevant market dataset from the plurality of financial services business profiles includes selecting one or more of the operation data and the performance data of the subject financial services business profile, wherein each of the financial services business profiles of the relevant market dataset includes selected data.

25. The computer storage medium of claim 22, further comprising assigning a weighted value to the selected data, wherein selecting the relevant market dataset from the plurality of financial services business profiles includes selecting the financial services business profile from the global dataset with the highest weighted value assigned to the selected operation data.

26. The computer storage medium of claim 22, wherein the practice type includes a sole practitioner type or a multi-advisor type and the revenue model type includes fee-only, commission-only, or a combination of fees and commissions.
